(19) United States
(12) Patent Application Publication
(10) Pub. No.: US 2021/0356072 A1
(43) Pub. Date: Nov. 18, 2021

(54) JACK STAND WITH INTERCHANGABLE SUPPORT TUBES

(71) Applicant: SUMMIT TOOL COMPANY DBA KEN-TOOL, Akron, OH (US)

(72) Inventor: Roger KLISKEY, Akron, OH (US)

(21) Appl. No.: 16/876,367

(22) Filed: May 18, 2020

(51) Int. Cl. F16M 11/28

(52) U.S. Cl. CPC F16M 11/28

(57) ABSTRACT

A jack stand comprising a base, a stem, and a plurality of interchangeable support tubes. Each support tube of the plurality of interchangeable support tubes is receivable within the base. Once one of the support tubes of the plurality of support tubes is in place within the base, the stem is then receivable within the interchangeable support tube.

### FIELD OF THE INVENTION

The present invention is generally directed toward a tool designed to be used after a vehicle or other load has been raised by a jack. More particularly, the present invention is directed to a jack stand. More specifically, the present invention is directed towards a jack stand having a base, a stem, and interchangeable support tubes received in the stem to allow the jack stand to support lifted vehicles at multiple heights once lifted by a jack.

### BACKGROUND OF THE INVENTION

A jack is a lifting device used to lift heavy loads. A mechanical jack employs a screw thread for lifting heavy equipment. A hydraulic jack uses hydraulic power. Jacks may be referred to as a car jack, a floor jack or a garage jack, any of which lifts vehicles or other heavy loads so that maintenance can be performed. If the jack remains in place after elevating a load, over time due to leakage of hydraulic fluid or wearing down of the screw thread, the jack gradually lowers the load. Furthermore, because most standard jacks are movable, so that the jack may be easily moved to many different portions of the heavy equipment, heavy equipment supported solely by a jack may be unstable and/or unsafe to work under. For this reason, the best practice is to use a jack stand placed under the load to maintain the load elevated and remove the jack once the jack stand is in place.

A jack stand is typically a stable platform for supporting the load. Because the jack and jack stand have individual and separate support structures, the jack stand and jack typically cannot support the vehicle at the same location on the frame. This can cause a problem when a manufacturer designates only certain locations as jacking locations. Generally, vehicle manufacturers reinforce certain locations on the frame of a vehicle so that those locations can support a portion of the weight of the vehicle when the vehicle is elevated with a jack (hereinafter these locations on the vehicle frame are referred to as “jacking locations”).

Generally, jack stands are pyramid-shaped structures having three or four sides and an adjustable support platform disposed in the top of the jack stand. For example, U.S. Pat. No. 7,207,548 discloses a more or less typical jack stand including four sides that form the shape of a pyramid, a telescoping support member extending from a top portion of the pyramid and a curved horizontal support, often having a U-shape, at the top of the telescoping support member to cradle a portion of the vehicle frame. The support member is often adjustable with a ratchet type mechanism. Problems occur with placement of this type of platform as only certain parts of the frame or undercarriage can fit in the curved horizontal support. While a jack stand is usually more stable than a jack, the jack stand cannot support the vehicle at the same point that is occupied by the jack. As a result, the jack stand often must be placed a considerable distance away from the jacking location in order to find a portion of the frame or undercarriage that is compatible with the top of the support platform, necessarily requiring a higher jacking elevation to accommodate the jack stand location.

Another problem with most jack stands is that they typically have a short height range, typically about 6 inches. Most jack stands only provide a lifting height no higher than double the base stand height of the jack stand. Thus, for a typical 6-inch jack stand, a total lift height of 12 inches would ordinarily be the maximum height obtained, for a range of 6 inches in total. Therefore, there is a need in the art for a jack stand that has the ability to provide a height range of more than double the base stand height of the jack stand while also providing a rigid and stable configuration. There is also a need for the jack stand to have features that allow quick and easy re-orientation of the jack stand underneath the load.

### SUMMARY OF THE INVENTION

In light of the foregoing, it is a first aspect of the present invention to provide a jack stand with interchangeable support tubes.

It is another aspect of the present invention to provide a jack stand comprising a base, a stem, and a plurality of interchangeable support tubes, wherein each support tube of the plurality of interchangeable support tubes is receivable within the base and wherein the stem is receivable within each interchangeable support tube of the plurality of support tubes.

It is a further aspect of the present invention to provide a jack stand for supporting a load, comprising a base having a bottom with an axially extending collar having a receiving aperture, at least one support tube, having an open end defined by a top edge and sized to be slidably received in the receiving aperture wherein the top edge has a pair of diametrically opposed recesses, a stem having a plurality of pin holes extending transversely therethrough, the stem receivable in the at least one support tube, and a locking pin receivable in one of the plurality of pin holes such that the locking pin rests in the pair of diametrically opposed recesses.

It is still another aspect of the present invention to provide a jack stand kit comprising a base having a bottom with an axially extending collar having a receiving aperture, a first support tube having a first height and a second support tube having a second height different than the first height, each support tube sized to be slidably received in the receiving aperture wherein each support tube has a top edge with a pair of diametrically opposed recesses, a stem having a plurality of pin holes extending transversely therethrough, the stem receivable in either of the support tubes, and a locking pin receivable in one of said plurality of pin holes such that the locking pin rests in said pair of diametrically opposed recesses, wherein the first and second tubes are interchangeable so that the jack stand can be configured for different ranges of heights depending upon where the locking pin is received in said pin holes.

### BRIEF DESCRIPTION OF THE DRAWINGS

For a more complete understanding of the features and advantages of the present invention, reference is now made to the detailed description of the invention along with the accompanying figures in which:

FIG. 1 is an exploded perspective view of a jack stand with a small support tube according to the concepts of the present invention;

FIG. 2 is an exploded perspective view of the jack stand with a large support tube according to the concepts of the present invention;

FIG. 3 is an elevational view, in partial cross-section, of the jack stand utilizing the small support tube according to the concepts of the present invention; and

FIG. 4 is an elevational view, in partial cross-section, of the jack stand utilizing the large support tube according to the concepts of the present invention.

### DETAILED DESCRIPTION OF ILLUSTRATIVE EMBODIMENTS

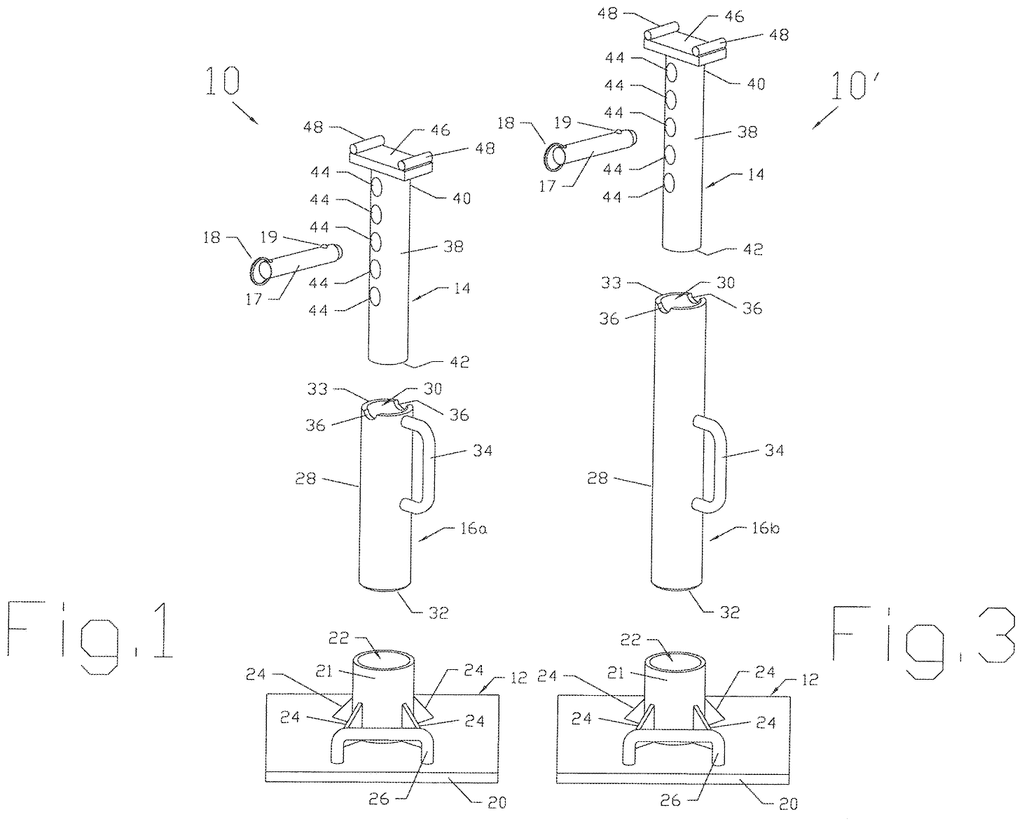

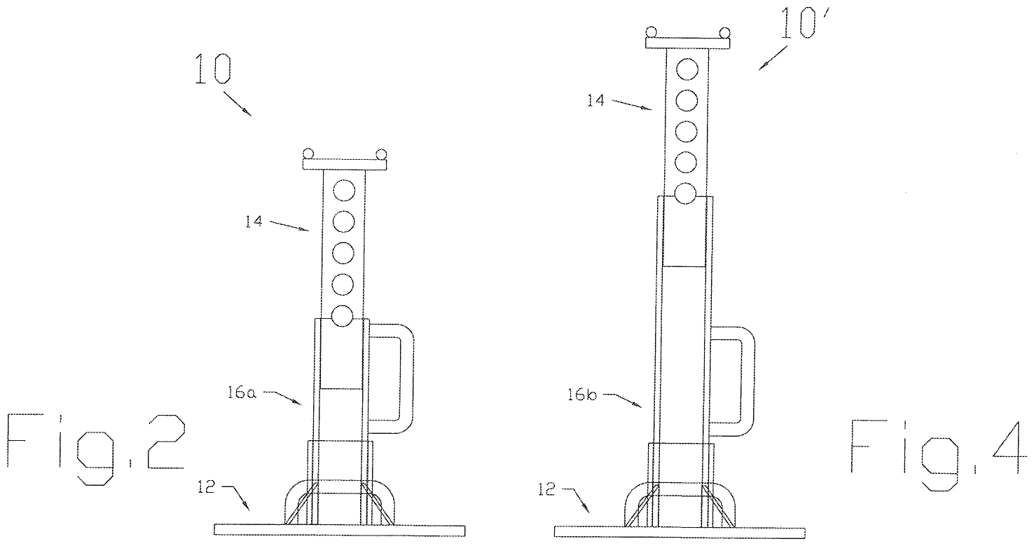

Referring now to FIGS. 1 and 2, a jack stand is designated generally by the numeral 10. FIGS. 3 and 4 show an alternative jack stand designated generally by the numeral 10′. Both jack stands 10 and 10′ generally include a base 12, a stem 14, at least one support tube 16a or 16b, and a locking pin 17. The jack stand 10 of the present invention is designed to be used with a plurality of support tubes having various heights. For example, jack stand 10 may use a support tube 16a, which is of a smaller height as shown in FIGS. 1 and 2, whereas jack stand 10′ may use a support tube 16b of relatively larger height as shown in FIGS. 3 and 4.

For both embodiments, base 12 includes a substantially flat bottom 20 from which axially extends upward a collar 21 which forms a receiving aperture 22. A plurality of gussets 24 may interconnect an upwardly facing surface of bottom 20 with a radial outer surface of collar 21. Gussets 24 provide radial and axial support to the collar 30 as to distribute any load forces applied to the collar into the bottom 20. At least one handle 26 may extend upwardly from the bottom 20 to allow a mechanic to move jack stand 10, 10′ as needed.

Each support tube 16a, 16b includes a tube body 28 having an upwardly facing open end 30 opposite a bottom facing open end 32. Open end 30 is defined by a top edge 33 of body 28. At least one handle 34 may extend radially and be oriented substantially lengthwise from support tube 16a, 16b as shown; however, skilled artisans will appreciate that other handle orientations and configurations may be used as long as they do not interfere with receipt of tube 16a, 16b in aperture 22 or operation of jack stand 10, 10′. Each support tube 16 may include locking pin recesses 36 diametrically across one another formed in top edge 33 at open end 30. Although not shown, skilled artisans will appreciate that additional pairs of diametrically opposed recesses 36 may be included in top edge 33. As will be discussed, this feature facilitates quick re-orientation of stem 14 with respect to tube 16a, 16b.

Stem 14 includes a stem body 38 having a top end 40 opposite a bottom end 42. Body 38 may be a solid or tubular construction. Extending transversely through body 38 may be a plurality of locking pin holes 44. In the embodiment shown, pin holes 44 are all aligned in the same direction, but in other embodiments, pin holes 44 may be in different angular orientations with respect to each other. Moreover, the pin holes 44 may be spaced in equal predetermined increments. A ram head 46 may be located at top end 40. The ram head 46 directly contacts and supports a raised load. In some embodiments of the present invention, edges of ram head 46 may have one or a pair of opposed raised flanges 48. The raised flanges 48 may be used to assist the mechanic in visually centering the head with respect to the load and to prevent the load from slipping off the jack stand.

Locking pin 17 may have a pull ring 18 at one end and at least one spring detent 19 at an opposite end. Pull ring 18 and spring detent 19 assist with the removal and retention of pin 17 in locking pin holes 44. It will be appreciated that pin 17 is sized to be slidably received in pin hole 44. Moreover, in the present embodiment, pin 17 has a circular cross-section and its' radius is substantially the same as the radius of the recesses 36. Other cross-sectional shapes of the pin may be employed in conjunction with a corresponding size and shape change for recesses 36.

To use jack stand 10, flat bottom 20 of base 12 is placed against a flat surface such as a garage floor. Then, end 32 of one of the support tubes 16a, 16b is placed into the tube receiving aperture 22 of base 12. Skilled artisans will appreciate that there may be a frictional fit between the outer surface of the tube body 28 with respect to the inner surface of the collar 21. A looser fit may be provided if desired. In any event, the rotational position of tube 16a, 16b with respect to base 12 may be adjusted by grasping one or both corresponding handles 34 and 26 and rotating one component with respect to the other. Next, the bottom end 42 of stem 14 is placed into the open end 30 of the support tube 16a, 16b. The position of stem 14 can vary within the support tube 16a, 16b by inserting the locking pin 17 into the appropriate locking pin hole 44 and then letting the locking pin 18 be received and rest within the locking pin recesses 36 located at top edge 33 of the support tube 16a, 16b. When pin 17 is received in pin hole 44 and rests in recesses 36, stem 14 and ram head 46 are rotationally set with respect to support tube 16a, 16b. However, the rotational position of head 46 can still be adjusted by rotating tube 16a, 16b within collar 22.

In use, the load to be supported by jack stand 10 is lifted to a predetermined height by a lift jack or other means, wherein the jack stand is configured to be set at a slightly lower height by pre-positioning the jack stand to a desired location and at a desired height. At this time, the lift jack may be slowly lowered so that the load is engaged and then supported by jack stand 10, 10′. Prior to the lowering of the load, the rotational position of stem 14 and/or tube 16a, 16b may be adjusted so that the load is properly seated on ram head 46 and between flanges 48. The way in which base 12, support tube 16a, 16b, and stem 14 interact with one another allows for jack stand 10 to provide a rigid structure that can support its load in an immobile manner.

Dependent upon how high the load has been raised by a jack or other means, the mechanic will choose to place either support tube 16a or 16b within the tube receiving aperture 22 of base 12. In one or more embodiments, support tube 16a is smaller in height than support tube 16b. In one or more embodiments, support tube 16a has a height of between about 4 and about 10 inches, in other embodiments, between about 5.5 and about 8.5 inches, and in yet other embodiments, between about 6 and about 8 inches. In one or more embodiments, support tube 16b has a height of between about 14 and about 20 inches, in other embodiments, between about 15.5 and about 18.5 inches, and in yet other embodiments, between about 16 and about 18 inches. In one or more embodiments, stem 14 has a height of between about 7 and about 14 inches, in other embodiments, between about 8.5 and about 12.5 inches, and in yet other embodiments, between about 9 and about 12 inches. In one or more embodiments, tube receiving aperture 22 has a height of between about 1 and about 5 inches, in other embodiments, between about 2 and about 4 inches, and in yet other embodiments, between about 2.5 and 3.5 inches. The dimensional relationship between the heights of the support tubes 16a and 16b and their respective pin holes is noteworthy. The difference in height is the same as the distance between the top and bottom holes 44 in stem 38. This allows the height of support tube 16b to “take over” exactly where the height of support tube 16a leaves off (6 inches, in this case). In other words, pinning the bottom hole 44 in stem 38 in support tube 16a and pinning the top hole 44 in support tube 16b, by design, results in the same overall height of the jack stand. This makes incremental height adjustments consistent from the shortest height using support tube 16a to the greatest height using support tube 16b.

In light of the foregoing, it should be appreciated that the present invention significantly advances the art by providing a jack stand with interchangeable support tubes that is structurally and functionally improved over the art in a number of ways. The primary advantage of the present embodiment is that the jack stand provides for interchangeable support tubes 16a, 16b that can be easily replaced to accommodate holding loads at different heights. The invention is also advantageous in that the base 12, and the stem 14 and support tube 16a, 16b sub-assembly are rotatable with respect to each other so as to ensure proper position of the jack stand prior to a load being placed thereon. Still another advantage is that the tubes 16a, 16b provide for recesses 36 at a top edge thereof that are sized and shaped to receive the height adjustment pin 17 after it is inserted into an appropriate locking pin hole 44 of stem 14. This allows for a secure rotational position of ram head 46, but also a quick disassembly of stem 14 from tubes 16a, 16b, as locking pin 17 does not need to be retracted from engagement with tube 16a, 16b. In other words, stem 14 can be axially withdrawn from tube 16a, 16b without first having to radially withdraw pin 17 from tube 16a, 16b. However, seating of pin 17 in recesses 36 while a load is supported by jack stand 10 helps prevent inadvertent rotational movement of stem 14 in the event of minor shifting or repositioning of the load. Skilled artisans will also appreciate that the jack stand is not a “telescoping device”. Telescoping components do not provide the lateral stability that is critical for jack stands of a telescopic device. Each additional “link” added to increase the height makes the assembly more unstable, side-to-side and front-to-back. This “flexibility” in a jack stand is not a plus with this kind of tool. Instead, the present jack stand is advantageous in that it provides interchangeable supports that are very stable so as to hold any type of load in an immobile position.

While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A jack stand comprising:
a base;
a stem; and
a plurality of interchangeable support tubes,
wherein each support tube of said plurality of interchangeable support tubes is receivable within said base and wherein said stem is receivable within each said interchangeable support tube of said plurality of support tubes.

2. The jack stand of claim 1, wherein the base comprises a substantially flat bottom, a collar having a tube receiving aperture, and a plurality of gussets connecting said collar and said flat bottom.

3. The jack stand of claim 1, wherein said stem comprises a stem body, a plurality of locking pin holes extending transversely through said stem body, and a ram head extending from one end of said stem body.

4. The jack stand of claim 3, further comprising:
a locking pin receivable within one of said plurality of locking pin holes in said stem body to support said stem in a position relative to said support tube of said plurality of support tubes received within said base.

5. The jack stand of claim 4, wherein each support tube of said plurality of interchangeable support tubes comprises a tube body having an open end.

6. The jack stand of claim 5, wherein said tube body has a top edge that defines said open end and wherein said top edge includes two locking pin recesses diametrically opposed to one another.

7. The jack stand of claim 6, wherein said plurality of interchangeable support tubes comprise a first support tube having a height smaller in comparison to a height of a second support tube.

8. The jack stand of claim 7, wherein the first support tube has a height of between about 4 and about 10 inches and wherein said second support tube has a height of between about 14 and about 20 inches.

9. The jack stand of claim 8, wherein said stem has a height of between about 7 and about 14 inches.

10. The jack stand of claim 9, wherein the base comprises a substantially flat bottom, a collar having a tube receiving aperture, and a plurality of support arms connecting said collar and said flat bottom, wherein the first support tube is receivable within the tube receiving aperture of the base, wherein the stem is placed within the open end of the first support tube, and wherein the locking pin is received within one of said plurality of locking pin holes in said stem, and then the locking pin rests within the two locking pin recesses of the first support tube.

11. The jack stand of claim 9, wherein the second support tube is receivable within the tube receiving aperture of the base, wherein the stem is placed within the open end of the second support tube, and wherein the locking pin is received within one of said plurality of locking pin holes in said stem, and then the locking pin rests within the two locking pin recesses of the second support tube.

12. A jack stand for supporting a load, comprising:
a base having a bottom with an axially extending collar having a receiving aperture;
at least one support tube having an open end defined by a top edge and sized to be slidably received in said receiving aperture, wherein said top edge has a pair of diametrically opposed recesses;
a stem having a plurality of pin holes extending transversely therethrough, said stem receivable in said at least one support tube; and
a locking pin receivable in one of said plurality of pin holes such that said locking pin rests in said pair of diametrically opposed recesses.

13. The jack stand according to claim 12, wherein said at least one support tube comprises a first support tube and a second support tube which has a different height than said first support tube.

14. The jack stand according to claim 12, wherein said bottom has a base handle extending therefrom.

15. The jack stand according to claim 12, wherein said at least one support tube has a tube handle extending therefrom.

16. The jack stand according to claim 12, wherein said bottom has a base handle extending therefrom and wherein said at least one support tube has a tube handle extending therefrom such that said base and said at least one support tube are rotatable with respect to each other by grasping and moving at least one of said base handle and said tube handle.

17. A jack stand kit comprising:
a base having a bottom with an axially extending collar having a receiving aperture;
a first support tube having a first height and a second support tube having a second height different than said first height, each support tube sized to be slidably received in said receiving aperture, each said support tube having a top edge with a pair of diametrically opposed recesses;
a stem having a plurality of pin holes extending transversely therethrough, said stem receivable in either of said support tubes; and
a locking pin receivable in one of said plurality of pin holes such that said locking pin rests in said pair of diametrically opposed recesses, wherein said first and second tubes are interchangeable so that the jack stand can be configured for different ranges of heights depending upon where said locking pin is received in said pin holes.
